(19) United States
(12) Patent Application Publication
(10) Pub. No.: US 2021/0362086 A1
(43) Pub. Date: Nov. 25, 2021

(54) METHOD OF AUTOMATICALLY FOLLOWING HUMAN FOR PURIFYING AIR NEARBY

(71) Applicant: POWER LOGIC TECH. INC., New Taipei City (TW)

(72) Inventors: Wen-Faung HSU, New Taipei City (TW); Chia-Heng HSU, New Taipei City (TW); Hung-Chou CHEN, New Taipei City (TW)

(21) Appl. No.: 16/882,720

(22) Filed: May 25, 2020

(51) Int. Cl. B01D 46/46; G01V 8/10; G01N 15/08; G05D 1/12; G05D 1/02; B60L 50/60; B60L 53/31; B60L 58/10; G05D 1/00; B01D 46/00; B01D 46/44; B01D 46/42

(52) U.S. Cl. CPC B01D 46/46; B60L 2240/54; G01N 15/0826; G05D 1/12; G05D 1/0225; B60L 50/66; B60L 53/31; B60L 58/10; G05D 1/0094; B01D 46/0086; B01D 46/446; B01D 46/4245; B01D 46/0043; G01N 2015/084; G01V 8/10

(57) ABSTRACT

A method of automatically following human for purifying air nearby is applied to a self-propelled air-purifying apparatus (1). The self-propelled air-purifying apparatus (1) moves by itself and purifies the ambient air by operating air-purifying module during moving. When detecting a human, the self-propelled air-purifying apparatus automatically follows the human and purifies the ambient air around the human by operating the air-purifying module during the following. The present disclosed example can effectively improve the air quality around the human.

### BACKGROUND OF THE INVENTION

### Field of the Invention

The technical field relates to air-purifying, and more particularly related to a method of automatically following human for purifying air nearby.

### Description of Related Art

The air purifier of the related art operates only at the fixed position, such that the air purifier can only purify the air around the fixed position. When there are a plurality of zones (such as a plurality of rooms), to make the human breathe the fresh air anytime and anywhere, a solution having been provided is siting the air purifier in each zone.

The above solution takes a lot of money to purchase air purifiers and a lot of time to replace consumables regularly, and takes a lot of indoor space to site the air purifiers. Moreover, to make each human entrancing to each zone breathes the fresh air, the air purifiers sited in the different zones must operate continuously even there is no human in the zone. The above solution has a problem of energy waste.

Thus, the air-purifying technologies in the related art have the above-mentioned problems, there is a need for a more effective solution.

### SUMMARY OF THE INVENTION

The present disclosed example is direct to a method of automatically following human for purifying air nearby having the ability to purify the air around the human.

One of the exemplary embodiments, a method of automatically following human for purifying air nearby is applied to a self-propelled air-purifying apparatus, the self-propelled air-purifying apparatus comprises an air-purifying module, a human-detecting module, a driving module and a control module, and the method of automatically following human for purifying air nearby comprises following steps: a) at the control module, controlling the driving module to move the self-propelled air-purifying apparatus; b) in motion, controlling the air-purifying module to operate for purifying the air around a motion route of the self-propelled air-purifying apparatus; c) when any human is detected by the human-detecting module in motion, controlling the driving module to follow the human being detected; and, d) in following the human, controlling the air-purifying module to operate for purifying the air around a motion route of the human.

The present disclosed example can reduce the expenditure to purify the air, and effectively improve the air quality around the human.

### BRIEF DESCRIPTION OF DRAWINGS

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is an architecture diagram of the self-propelled air-purifying apparatus according to the first implement aspect of the present disclosed example;

FIG. 2 is an architecture diagram of the self-propelled air-purifying apparatus according to the second implement aspect of the present disclosed example;

FIG. 3 is an architecture diagram of the control module according to the third implement aspect of the present disclosed example;

FIG. 4 is a schematic view of usage of the self-propelled air-purifying apparatus according to one example of the present disclosed example;

FIG. 5 is a schematic view of usage of the self-propelled air-purifying apparatus according to one example of the present disclosed example;

FIG. 6 is a schematic view of usage of the self-propelled air-purifying apparatus according to one example of the present disclosed example;

FIG. 7 is a flowchart of the method of automatically following human for purifying air nearby according to the first embodiment of the present disclosed example;

FIG. 8 is a flowchart of the method of automatically following human for purifying air nearby according to the second embodiment of the present disclosed example; and

FIG. 9 is a flowchart of the patrol purification function according to the third embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

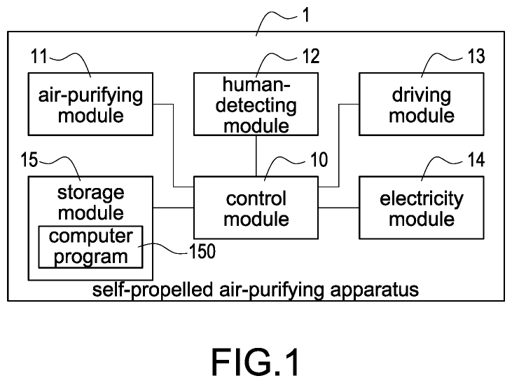

Please refer to FIG. 1 which is an architecture diagram of the self-propelled air-purifying apparatus according to the first implement aspect of the present disclosed example.

The present disclosed example mainly provides a method of automatically following human for purifying air nearby (hereinafter “the method” for abbreviation) applied to a self-propelled air-purifying apparatus 1 described later. The self-propelled air-purifying apparatus 1 can automatically move to the different zones to execute the air-purifying, and break the technical prejudice that the air purifier can only be set at a fixed position.

Moreover, the self-propelled air-purifying apparatus 1 of the present disclosed example can further follow the human for purifying the air around the human and improving the air quality around the human.

Thus, by using the present disclosed example, the human can breathe the fresh air anytime and anywhere without setting a plurality of air purifiers.

The self-propelled air-purifying apparatus 1 of the present disclosed example mainly comprises an air-purifying module 11, a human-detecting module 12, a driving module 13, an electricity module 14, a storage module 15 and a control module 10 electrically connected to the above modules.

The air-purifying module 11, such as a combination of an airflow generating device and a filter, is used to purify the air nearby. The human-detecting module 12 is used to detect whether there is an object (such as a human) near the self-propelled air-purifying apparatus 1. The driving module 13, such as comprising a motor and the power wheels, is used to move the self-propelled air-purifying apparatus 1, so as to make the self-propelled air-purifying apparatus 1 have the ability to operate in the different positions. The electricity module 13, such as the battery, is used to store electricity and provide electricity required for the movement and operation of the self-propelled air-purifying apparatus 1. The storage module 15 is used to store data. The control module 10 is used to control each module of the self-propelled air-purifying apparatus 1 to operate.

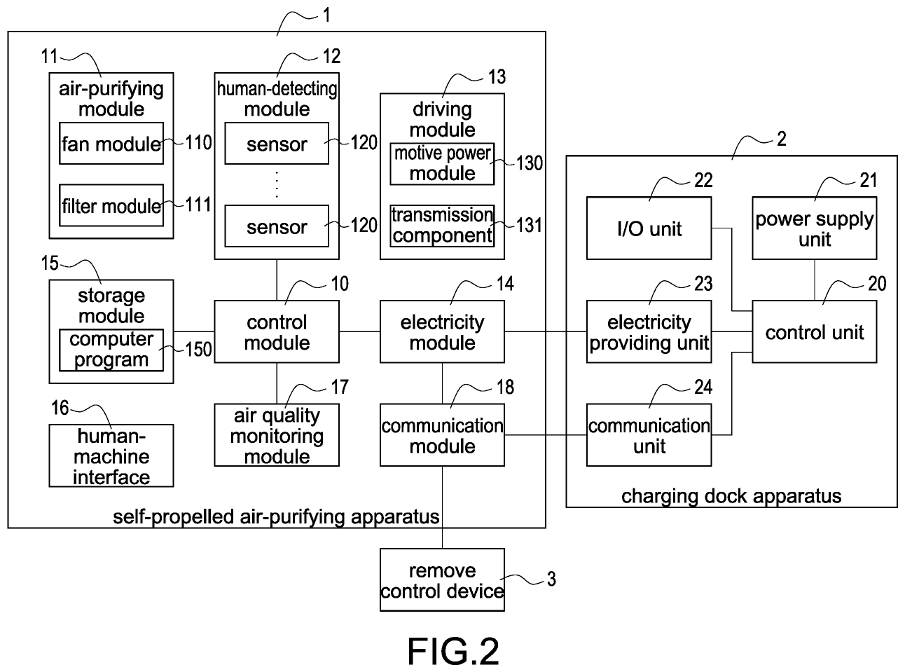

Please refer to FIG. 2 together. FIG. 2 is an architecture diagram of the self-propelled air-purifying apparatus according to the second implement aspect of the present disclosed example.

In this implement aspect, the air-purifying module 11 may comprise a fan module 110 and a filter module 111, such as activated carbon filter, HEPA filter, and so forth. The fan module 11 may be controlled by the control module 10 to adjust its rotation rate for generating the airflows with a different intensity. Moreover, this airflow can drive the air around the air-purifying module 11 to penetrate the filter module 111 for achieving the effect of purifying the air.

In this implement aspect, the human-detecting module 12 may comprise one or more sensor(s) 120, such as PIR (passive infrared sensor) sensor, ultrasonic sensor, image capturing device, proximity sensor, thermal sensor and so forth, but this specific example is not intended to limit the scope of the present disclosed example. The above-mentioned sensor(s) 120 may be used to detect the moving objects and/or fixed objects around it based on its type.

One of the implement aspects, the human-detecting module 12 may be set only one sensor 120, this sensor 120 is directional and only triggered by the movement of an object (such as a PIR sensor). The self-propelled air-purifying apparatus 1 may continually rotate its main body or the PIR sensor to make the PIR sensor scan towards different directions in the indoor. When the PIR sensor is triggered, it is determined that the current direction being scanned by the sensor 120 is such the direction of the object. By constantly repeating the above steps, the present disclosed example can use the single sensor 120 to implement the object following, and reduce the apparatus cost.

Please be noted that the above-mentioned implement aspect does not have the ability to detect the immovable objects, such as furniture, wall surface and so forth, but there is no need for the immovable objects to purity the air nearby. Moreover, for objects pausing moving (such as the person sitting in a chair), the user experience does not deteriorate because the objects pausing moving had moved previously. Namely, the self-propelled air-purifying apparatus 1 of the present disclosed example had followed the object pausing moving and purified the air around the objects pausing moving previously.

One of the implement aspects, the driving module 13 comprises a motion power module 130 (such as motor) and transmission components 131 (such as a combination of gears, driveshafts, tires, and the other power components). The control module 10 may control the motion power module 130 to operate and adjust its rotation rate, and control the transmission component 131 to dynamically adjust the motion direction.

One of the implement aspects, the self-propelled air-purifying apparatus 1 further comprises a human-machine interface 16 (such as indicators, buttons, touchpad, display, speaker, buzzer, or any combination of the above device) electrically connected to the control module 10 and used to interact with human and/or output information.

One of the implement aspects, the self-propelled air-purifying apparatus 1 further comprises an air quality monitoring module 17 electrically connected to the control module 10. The air quality monitoring module 17 is used to monitor the air quality, such as the air quality before purifying and/or the air quality after purifying.

One of the implement aspects, the self-propelled air-purifying apparatus 1 further comprises a communication module 108 electrically connected to the control module 10, such as NFC module, Bluetooth module, Wi-Fi module, cellular network module, Zigbee module, Ethernet module, infrared receiver or any combination of the above communication devices.

One of the implement aspects, the human could operate a remote control device 3 (such as a remote controller to a mobile device connecting to the network and installed the designated application program) to generate and send an operation command to the communication module 18, the control module 10 controls the self-propelled air-purifying apparatus 1 based on the received operation command, such as moving to the designated position, adjusting the airflow speed, adjusting the airflow direction, returning to home for charging, power off and so forth.

One of the implement aspects, the self-propelled air-purifying system comprises the self-propelled air-purifying apparatus 1 and a charging dock apparatus 2 installed at the fixed position. The charging dock apparatus 2 is used to removably connect to the self-propelled air-purifying apparatus 1, and charges the battery of the self-propelled air-purifying apparatus 1 after connecting to the self-propelled air-purifying apparatus 1.

More specifically, the charging dock apparatus 2 may comprise a power supply unit 21, an I/O unit 22, an electricity providing unit 23, a communication unit, and a control unit 20 used to control the above units.

The power supply unit 22 is used to receive electricity from outside (such as supply mains), and provide the electricity to the charging dock apparatus 2 for operation. The I/O unit 22 is similar as the above-mentioned human-machine interface 16 and used to interact with human and/or output information.

The electricity providing unit 23 is used to couple with the electricity module 114 of the self-propelled air-purifying apparatus 1. One of the implement aspects, each of the electricity providing unit 23 and the electricity module 14 has a charging interface for coupling each other. When their charging interfaces touch each other, the electricity could be transferred by the coupled charging interfaces.

The communication unit 24 is similar as the above-mentioned communication module 18, and used to communicate with the communication module 18.

One of the implement aspects, after the communication unit 24 communicatively connects to the communication module 18 of the self-propelled air-purifying apparatus 1, the control unit 20 may retrieve the apparatus information of the self-propelled air-purifying apparatus 1, verify the retrieved apparatus information, and control the electricity providing unit 23 to charge the electricity module 14 if the apparatus information is approved. Thus, the present disclosed example can prevent from wasting electricity or damaging apparatus caused by charging the incompatible or incorrect self-propelled air-purifying apparatus 1.

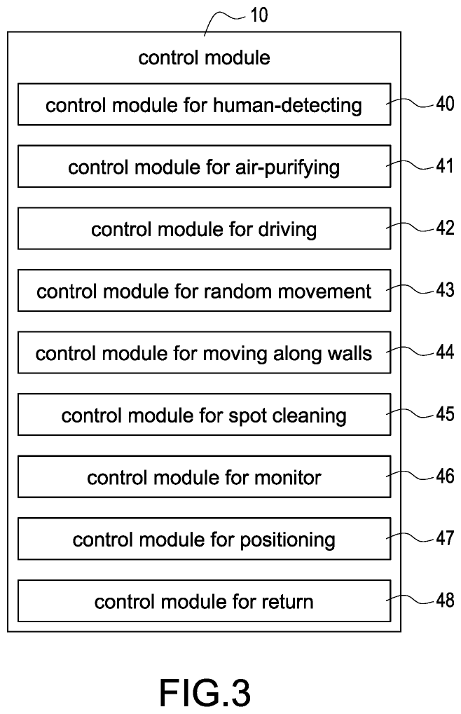

Please refer to FIG. 3 together. FIG. 3 is an architecture diagram of the control module according to the third implement aspect of the present disclosed example. In the present disclosed example, the control module 10 may comprise following modules for implementing the different functions:

1. the control module for human-detecting 40, used to control the human-detecting module 12, such as retrieving the sensing data and determining whether any human is detected based on the sensing data.

2. the control module for air-purifying 14, used to control the air-purifying module 11 to operate.

3. the control module for driving 42, used to control the driving module 13 for adjusting the motion direction and the motion speed.

4. the control module for random movement 43, used to generate a random route. The control module 10 controls the self-propelled air-purifying apparatus 1 to move along the above-mentioned random route when it does not detect any human. The above-mentioned random route can implement the following purposes: looking for people, looking for wall and purifying the air at random position in the room.

5. the control module for moving along walls 44, used to generate a route along walls based on the positions of the walls if any wall is detected. The control module controls the self-propelled air-purifying apparatus 1 to move along the above-mentioned route along walls for detouring indoor to complete the purification of indoor air when no human is detected and at least one wall is detected.

6. the control module for spot cleaning 45, used to control the self-propelled air-purifying apparatus 1 to stop moving and execute the spot cleaning for quickly improving the air quality in the currently located zone. For example, the above operation may be executed when the air quality of the ambient air is unhealthy or worse. The control module for spot cleaning 45 is further used to control the self-propelled air-purifying apparatus 1 to terminate the spot cleaning and continue to move when a condition to discontinue spot cleaning is met. The above condition to discontinue spot cleaning may be stored in the storage module 15, and comprise the designated time period elapsing or the air quality has been improved.

One of the implement aspects, the control module 10 may control the self-propelled air-purifying apparatus 1 to move along the planned patrol route after switching to the patrol purification mode, and control the air-purifying module 11 to operate in motion for continuously purifying the air around the patrol route. Moreover, the control module 10 may control the self-propelled air-purifying apparatus 1 to stop moving and execute the above-mentioned spot cleaning when detecting that the air quality is worse than a default standard quality, and then control the self-propelled air-purifying apparatus 1 to continue to move along the patrol route after completion of the spot cleaning.

7. the control module for monitor 46, used to execute each of the monitoring functions, such as monitoring filter life, fan performance, operating time, air quality and so forth.

One of the implement aspects, the control module 10 may comprise a timer. The timer may be used to count the accumulated usage time of the filter module 11, and the control module 10 could issue a filter replacement notification by the human-machine interface 16 when the accumulated usage time is over a default filter lifetime which cloud be stored in the storage module 15.

One of the implement aspects, the sensors 120 (such as airflow speed sensor or pressure sensor) may be installed on the filter module 111, the sensors 120 are used to sensor the airflow pressures of inlet and outlet of the filter module 111, and the control module 10 filter replacement notification by the human-machine interface 16 when a pressure difference between inlet and outlet of the filter module 111 is higher than a default filter pressure difference which could be stored in the storage module 15.

One of the implement aspects, the air quality monitoring module 17 may be used to sensor the air quality of the outlet of the filter module 111 (namely, the air quality of the purified air). The control module for monitor 46 issues the filter replacement notification by the human-machine interface 16 when the air quality at the outlet of the filter module 111 is worse than the default filter quality which could be stored in the storage module 15.

One of the implement aspects, control module for monitor 46 may monitor the operational efficiency of the fan module 111, and issue a fan replacement notification by the human-machine interface 16 when the operational efficiency is lower than a default fan efficiency which could be stored in the storage module 15.

8. the control module for positioning 48, used to retrieve the current position of the self-propelled air-purifying apparatus 1. It is a common technique that retrieving the current position indoor (such as retrieving the current position based on indoor positioning, retrieving the current position based on the position of the charging dock apparatus 2 and the motion track of the self-propelled air-purifying apparatus 1), the relevant description is omitted for brevity.

9. the control module for return 48, used to retrieve a charging dock position which the charging dock apparatus 2 is located, plan the return route based on the current position and the charging dock position, and control the driving module 13 to move to the charging dock position to connect to a charging dock apparatus 2 for charging when a battery level of an electricity module 14 is less than a default sufficient battery level which could be stored in the storage module 15, or reception of a return command.

Thus, the present disclosed example can achieve the function of self-propelled air-purifying and the function of following the human to purify the air nearby.

Please be noted that, the above-mentioned modules 40-47 are connected to each other (such as by electrical connection or information link), and each module 40-47 could be a hardware module, a software module or a combination of the hardware module and the software module, this specific example is not intended to limit the scope of the present disclosed example.

Please be noted that if each of the above-mentioned modules 40-48 is the software module, such as firmware, operating system or application program, the storage module 15 may comprise a non-transitory computer-readable media. The non-transitory computer-readable media stores a computer program 150. The computer program records a plurality of computer-readable codes. When the control module 10 executes the above computer-readable codes, the control functions of the corresponding above-mentioned modules 40-48 can be achieved.

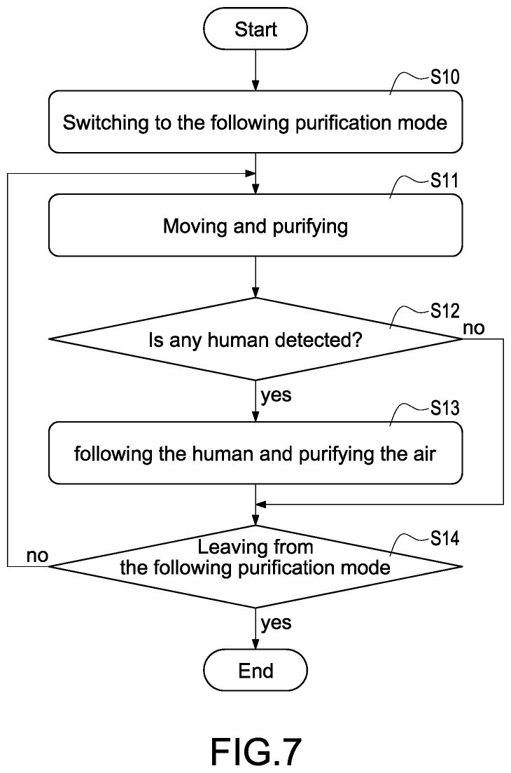

Please refer to FIG. 7 together. FIG. 7 is a flowchart of the method of automatically following human for purifying air nearby according to the first embodiment of the present disclosed example. In particular, the method of each embodiment of the present disclosed example may be implemented by the apparatus and system shown in FIG. 1 and FIG. 2. More specifically, the method of this embodiment comprises following steps.

Step S10: the control module 10 switches to the following purification mode automatically or for responding to the user operation. In the following purification mode, the self-propelled air-purifying apparatus 1 may automatically search for one human and follow the human for continuously improving the air quality around the human.

Step S11: the control module 10 controls the driving module 13 to move the self-propelled air-purifying apparatus 1 by the control module for driving 42 (the motion may be moving randomly or moving along the planned route), and simultaneously controls the air-purifying module 11 by the control module for air-purifying 41 to operate in motion for purifying the air around the motion route of the self-propelled air-purifying apparatus 1.

Step S12: the control module 10 determines whether any human is detected nearby in motion by the control module for human-detecting 40.

If any human is detected, the control module 10 performs a step S13: the control module 10 controlling the driving module 13 by the control module for driving 42 to drive the self-propelled air-purifying apparatus 1 to keep following the human, and continuously controlling the air-purifying module 11 by the control module for air-purifying 41 to operate in following for purifying the ambient air around the motion route of the human. Thus, the human can continuously breathe the air which the air quality has been improved.

If no human is detected in the step S12 or the performing of the step S14 finished, the control module 10 performs a step S14: the control module 10 determining whether leaving from the following purification mode, such as the user disabling the function of following and purification, no human being detected for the default time interval or so forth.

If it is unnecessary to leave from the following purification mode, the control module 10 performs the step S11 again. Otherwise, the control module 10 discontinues the execution of following and purification.

The present disclosed example can save the expenditure for air purification, and make the human breathe the fresh air anytime and anywhere with only one air-purifying.

One of the exemplary embodiments, the storage module 15 may store a fan rotation rate for motion and a fan rotation rate for following, the fan rotation rate for motion is faster than the fan rotation rate for following. In the above-mentioned step S11, the fan module 110 of the air-purifying module 11 is controlled based on the fan rotation rate for motion for operating with higher rotation rate. In the above-mentioned step S13, the fan module 110 of the air-purifying module 11 is controlled based on the fan rotation rate for following for operating with slower rotation rate. Thus, the present disclosed example can lower the operating volume in following human, so as to prevent the human from feeling dislikeable caused by the operational noise.

One of the exemplary embodiments, the storage module may store the first fan rotation rate for motion and the second fan rotation rate for motion. The first fan rotation rate for motion is higher than the second fan rotation rate for motion. In the above-mentioned step S11, the control module 10 controls the air-purifying module 11 to operate with a higher rotation rate based on the first fan rotation rate for motion to improve the purification efficiency when the air quality of ambient air is worse than the default standard quality (namely, the air quality is unhealthy). And the control module 10 controls the air-purifying module 11 to operate with a lower rotation rate based on the second fan rotation rate for motion to low the voice noise when the air quality is not worse than the default standard quality (namely the air quality is good).

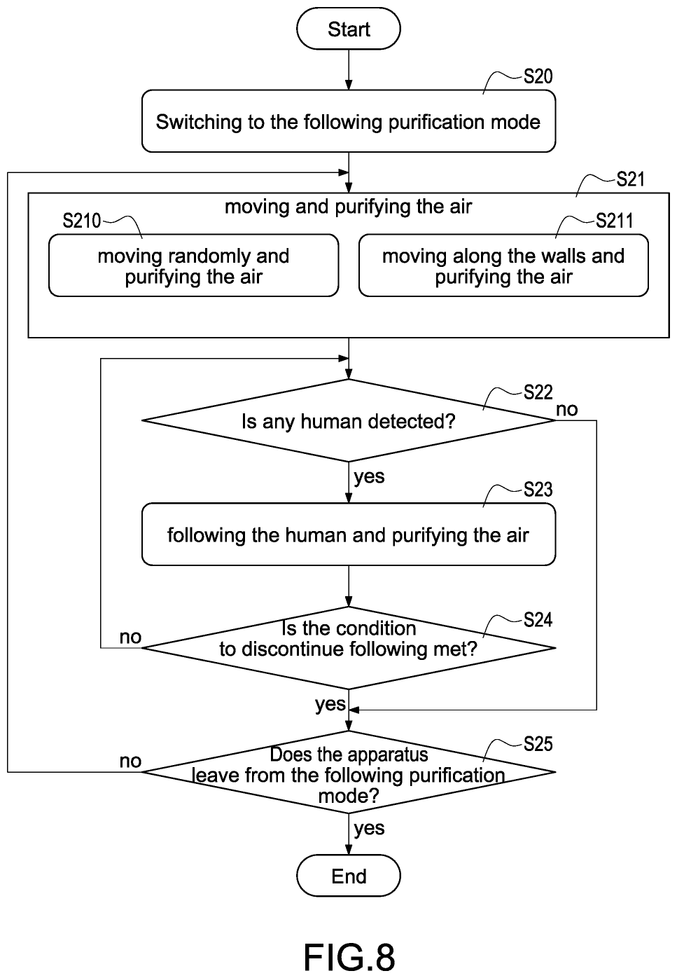

Please refer to FIG. 8 together. FIG. 8 is a flowchart of the method of automatically following human for purifying air nearby according to the second embodiment of the present disclosed example. More specifically, the method of this embodiment comprises the following steps.

Step S20: the control module 10 switches to the following purification mode.

Step S21: the control module 10 controls the self-propelled air-purifying apparatus 1 to move and simultaneously controls the air-purifying module 11 to operate in motion for purifying the ambient air.

One of the exemplary embodiments, the control module 10 may perform following steps S210 or S211 to control the motion.

Step S210: the control module 10 plans a random route by the control module for random movement 43, and controls the self-propelled air-purifying apparatus 1 to randomly move based on the random route to look for the human.

Step S211: the control module 10 plans a route along walls by the control module for moving along walls 43, and control the self-propelled air-purifying apparatus 1 to move along the walls based on the route along walls to look for the human.

One of the exemplary embodiments, the control module 10 may perform the steps S210 and S211 to control the motion. More specifically, the control module 10 firstly controls the self-propelled air-purifying apparatus 1 to move randomly (step S210), plans the route along walls based on the positions of the walls when any wall is detected by the sensor 120, and move along the walls (step S211).

Step S22: the control module 10 determines whether any human is detected.

If no human is detected, the control module 10 performs the step S25.

If any human is detected, the control module 10 performs a step S23: the control module 10 controlling the self-propelled air-purifying apparatus 1 to continuously follow the human being detected, and continuously controlling the air-purifying module 41 to operate continuously in following for purifying the air around the human.

Step S24: the control module 10 determines whether a condition to discontinue following being set previously is met, the condition to discontinue following may be store in the storage module 15.

If the control module 10 determines that the condition to discontinue following is met, the following human is discontinued. If the control module 10 determines that the condition to discontinue following is not met. the control module 10 performs the step S22 again for continuously detecting and following the human.

One of the exemplary embodiments, the above-mentioned condition to discontinue following may comprises keeping following the human for a default following time to follow, the air quality of ambient air being worse than a default standard quality (namely, it is urgent to purify the ambient air with high efficiency), the self-propelled air-purifying apparatus 1 being pushed by an external force, and/or reception of stopping following command.

For example, if the condition to discontinue following is configured to be keeping following the human for the default following time interval (such as 3 minutes), the control module 10 may comprise a timer for counting the above default following time interval.

For example, if the condition to discontinue following is configured to be the air quality of ambient air being worse than the default standard quality, the control module 10 may determine whether the air quality is worse than the default standard quality by the control module for monitor 46.

For example, if the condition to discontinue following is configured to be the self-propelled air-purifying apparatus 1 being pushed by the external force, the control module 10 may determine by the control module for driving 42 and the control module for monitor 46 whether the self-propelled air-purifying apparatus 1 is pushed or moved by the external force based on the motive power (or its variation) outputted by the motion power module 460.

Step S25: the control module 10 determines whether leaving from the following purification mode, such as the user disabling the function of following and purification, no human being detected for the default time interval or so forth.

If it is unnecessary to leave from the following purification mode, the control module 10 performs the step S21 again. Otherwise, the control module 10 discontinues the execution of following and purification.

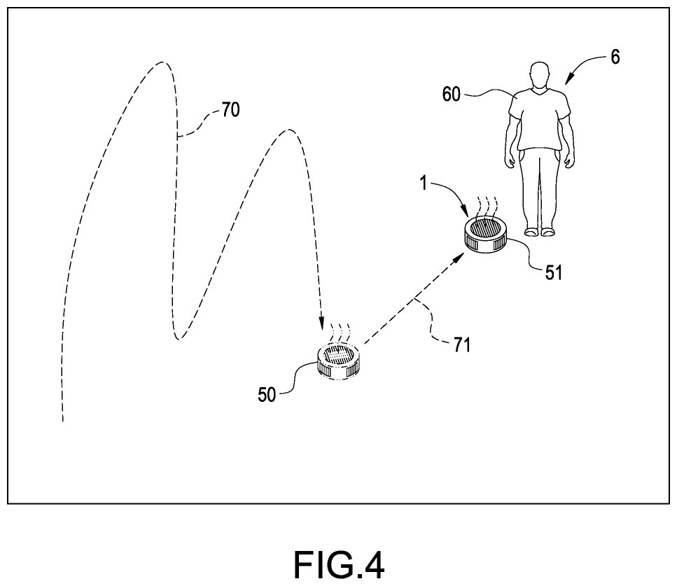

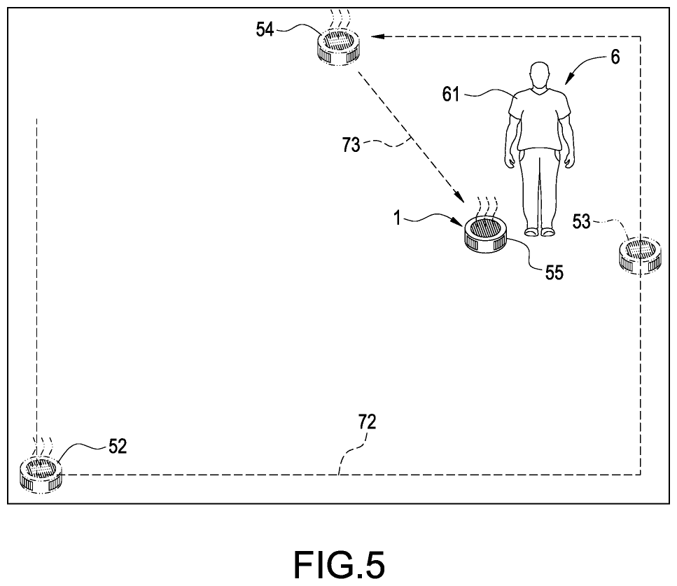

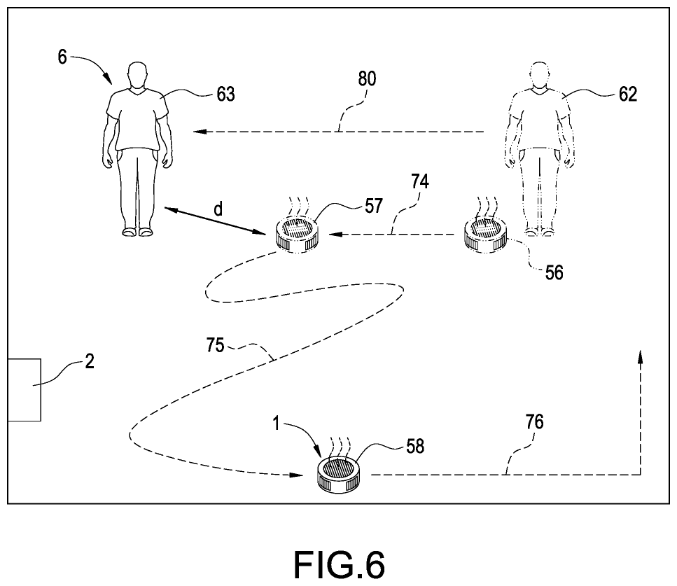

Please refer to FIG. 4 to FIG. 6 together/. FIG. 4 is a schematic view of usage of the self-propelled air-purifying apparatus according to one example of the present disclosed example, FIG. 5 is a schematic view of usage of the self-propelled air-purifying apparatus according to one example of the present disclosed example, and FIG. 6 is a schematic view of usage of the self-propelled air-purifying apparatus according to one example of the present disclosed example. FIG. 4 to FIG. 6 are used to exemplary explain the operational situation of the self-propelled air-purifying apparatus 1 of the present disclosed example.

As shown in FIG. 4, the self-propelled air-purifying apparatus 1 randomly moves for searching any human and along the random route 70 generated based on random. When the self-propelled air-purifying apparatus 1 moves to the apparatus position 50, the self-propelled air-purifying apparatus 1 may plan the route 71 because of the detection of the human 6 located at the human position 60, move to the apparatus position 51 along the route 71 to start to follow the human 6, and purify the air around the human 6.

As shown in FIG. 5, the self-propelled air-purifying apparatus 1 moves along walls for searching any human and simultaneously purifies the indoor air. Moreover, the self-propelled air-purifying apparatus 1 moves along the route along walls 72 being planned. When the self-propelled air-purifying apparatus 1 moves from the apparatus position 52 though the apparatus position 53 to the apparatus position 54, the self-propelled air-purifying apparatus 1 may plan the route 73 because of the detection of the human 6 located at the human position 61, move to the apparatus position 55 along the route 73 to start to follow the human 6, and purify the air around the human 6.

As shown in FIG. 6, when the human 6 moves along the route 80 from the human position 62 to the human position 63, the self-propelled air-purifying apparatus 1 may follow the human 6 and move to the apparatus position 57 along the corresponding following route 74 from the apparatus position 56. Moreover, the self-propelled air-purifying apparatus 1 may keep a default distance d (such as 2 meters) from the human 6 for preventing from influencing the human 6.

Then, the self-propelled air-purifying apparatus 1 stops following the human 6 when determining that the condition to discontinue following is met. Moreover, the self-propelled air-purifying apparatus 1 moves along the random route 75 to search for the wall surface, and the wall is detected when moving to the apparatus position 58. Then, the self-propelled air-purifying apparatus 1 plans the route along walls 76, and moves along the walls to search another human or continue to purify the indoor air.

Besides, when the self-propelled air-purifying apparatus 1 detects a remaining battery level is too low, such as being less than a default sufficient battery level, the self-propelled air-purifying apparatus 1 may automatically execute a return operation to go back to the position of the charging dock apparatus 2 for charging, and continue to roam and purify the indoor air after the completion of charging. In one example, in charging, the self-propelled air-purifying apparatus 1 may continuously purify the air around the charging dock apparatus 2.

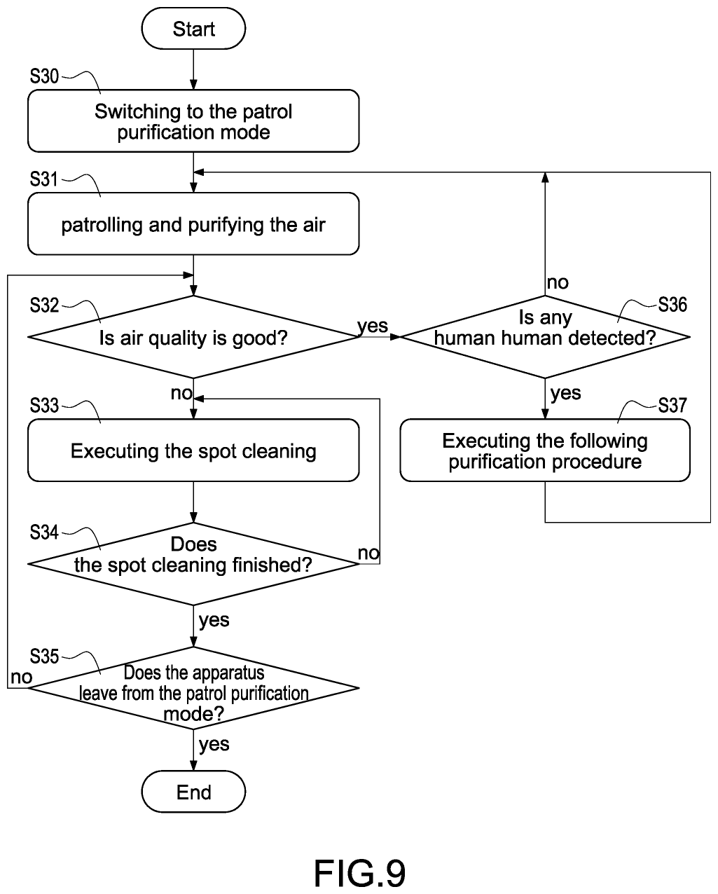

Please refer to FIG. 9 together. FIG. 9 is a flowchart of the patrol purification function according to the third embodiment of the present disclosed example. More specifically, the method of this embodiment comprises the following steps.

Step S30: the control module 10 switches to a patrol purification mode. In the patrol purification mode, the control module 10 may control the self-propelled air-purifying apparatus 1 to go to a designated patrol position and execute the air purification, or move along a designated patrol route and simultaneously execute the air purification in motion.

Step S31: the control module 10 controls the self-propelled air-purifying apparatus 1 to move along the patrol route to the patrol position, and controls the air-purifying module 11 to operate simultaneously in motion for purifying the air around the route.

Step S32: the control module 10 determines whether the air quality at the current position is good by the air quality monitoring module 17.

If the air quality is unhealthy or moderate (such as being worse than the default standard quality), the control module 10 performs a step S33: the control module 10 executing the spot cleaning. More specifically, the control module 10 may control the self-propelled air-purifying apparatus 1 to stop moving, and operate the air-purifying module 11 in place (such as operation with a higher fan rotation rate) or quickly improving the air quality at the current position.

Step S34: the control module 10 determines whether a condition to discontinue spot cleaning is met. The condition to discontinue spot cleaning may comprise the air quality is not worse than the default standard quality, staying for a default time interval and/or so forth.

If the condition to discontinue spot cleaning is not met, the control module 10 performs the step S33 again for continuously executing the spot cleaning.

If the condition to discontinue spot cleaning is met, the control module 10 controls the self-propelled air-purifying apparatus 1 to continue to move along the patrol path or towards the patrol position, and performs a step S35: the control module 10 determines whether leaving from the patrol purification mode, such as the user disabling the patrol purification function, the air qualities of all of the zones being good, no human being detected for a default time, and/or so forth.

If it is unnecessary to leave from the patrol purification mode, the control module 10 performs the step S32 again. Otherwise, the control module 10 discontinues the execution of patrol purification.

If the control module 10 determines that the air quality is good in the step 32 (such as being not worse than the default standard quality), the control module 10 performs a step S36: the control module 10 determines whether any human is detected.

If the control module 10 determines that no human is detected, the control module 10 performs the step S31 again.

If the control module 10 detects any human, the control module 10 performs a step S37: the control module 10 switching to the following purification mode for executing the function of following and purification.

One of the exemplary embodiments, the control module 10 is configured to performs the steps S12-S14 and the step S11 shown in FIG. 7.

The above-mentioned are only preferred specific examples in the present disclosed example, and are not thence restrictive to the scope of claims of the present disclosed example. Therefore, those who apply equivalent changes incorporating contents from the present disclosed example are included in the scope of this application, as stated herein.

What is claimed is:

1. A method of automatically following human for purifying air nearby applied to a self-propelled air-purifying apparatus (1), the self-propelled air-purifying apparatus (1) comprising an air-purifying module (11), a human-detecting module (12), a driving module (13) and a control module (10), the method of automatically following human for purifying air nearby comprising following steps:
a) at the control module (10), controlling the driving module (13) to move the self-propelled air-purifying apparatus (1);
b) in motion, controlling the air-purifying module (11) to operate for purifying the air around a motion route of the self-propelled air-purifying apparatus (1);
c) when any human is detected by the human-detecting module (12) in motion, controlling the driving module (13) to follow the human being detected; and
d) in following the human, controlling the air-purifying module (11) to operate for purifying the air around a motion route of the human.

2. The method of automatically following human for purifying air nearby according to claim 1, wherein the step a) is performed to control the self-propelled air-purifying apparatus (1) to move randomly.

3. The method of automatically following human for purifying air nearby according to claim 1, wherein the step a) is performed to control the self-propelled air-purifying apparatus (1) to move randomly, and move along a wall after detecting the wall by a sensor (120).

4. The method of automatically following human for purifying air nearby according to claim 1, further comprising a step e) stopping following the human when a condition to discontinue following is met.

5. The method of automatically following human for purifying air nearby according to claim 4, wherein the condition to discontinue following comprising keeping following the human for a default following time to follow, air quality of ambient air being worse than a default standard quality, or the self-propelled air-purifying apparatus (1) being pushed by an external force.

6. The method of automatically following human for purifying air nearby according to claim 1, further comprising following steps:
in a patrol purification mode, moving along a patrol route, and controlling the air-purifying module (22) to operate for purifying ambient air around the patrol route in motion;
executing spot cleaning when detecting that air quality at a current position is worse than a default standard quality;
continuing to move along the patrol route when a condition to discontinue spot cleaning is met; and
switching to a following purification mode to perform the steps a) to d) when detecting that the air quality at the current position is not worse than the default standard quality and any human is detected.

7. The method of automatically following human for purifying air nearby according to claim 1, wherein the step b) is performed to controlling the air-purifying module (11) to operate with a fan rotation rate for motion; the step d) is performed to controlling the air-purifying module (11) to operate with a fan rotation rate for following; the fan rotation rate for motion is faster than the fan rotation rate for following.

8. The method of automatically following human for purifying air nearby according to claim 1, wherein the step b) is performed to control the air-purifying module (11) to operate with a first fan rotation rate for motion when air quality of ambient air is worse than a default standard quality, control the air-purifying module (11) to operate with a second fan rotation rate for motion when the air quality is not worse than the default standard quality, the first fan rotation rate for motion is faster than the second fan rotation rate for motion.

9. The method of automatically following human for purifying air nearby according to claim 1, further comprising following steps:
issuing a filter replacement notification when an accumulated usage time of a filter module (111) of the air-purifying module (11) counted by a timer is over a default filter lifetime, a pressure difference between inlet and outlet obtained by a sensor (120) is higher than a default filter pressure difference, or air quality at the outlet of the filter module (111) is worse than a default filter quality; and
issuing a fan replacement notification when an operational efficiency of a fan module (110) of the air-purifying module (11) is lower than a default fan efficiency.

10. The method of automatically following human for purifying air nearby according to claim 1, further comprising a step of when a battery level of an electricity module (14) of the self-propelled air-purifying apparatus (1) is less than a default sufficient battery level, planning a return route based on a current position and a charging dock position, and controlling the self-propelled air-purifying apparatus (1) to move to the charging dock position to connect to a charging dock apparatus (2) for charging.
